(19) United States
(12) Patent Application Publication
(10) Pub. No.: US 2025/0349141 A1
(43) Pub. Date: Nov. 13, 2025

(54) SUPPORT VECTOR MACHINE (SVM) AND NEUROSYMBOLIC ARTIFICIAL INTELLIGENCE (AI)-BASED SYSTEM FOR INTELLIGENT DOCUMENT TAMPERING IDENTIFICATION

(71) Applicant: BANK OF AMERICA CORPORATION, Charlotte, NC (US)

(72) Inventors: Yingcai Peng, Celina, TX (US); Maneesh Kumar Sethia, Hyderabad (IN); Sivashalini Sivajothi, Tamil Nadu (IN); Shubhangi Balasaheb Gite, Maharashtra (IN); Hanmant Tanaji Desai, Maharashtra (IN); Ritesh Shalik Borole, Maharashtra (IN)

(73) Assignee: BANK OF AMERICA CORPORATION, Charlotte, NC (US)

(21) Appl. No.: 18/659,260

(22) Filed: May 9, 2024

(51) Int. Cl. G06V 20/00; G06V 30/412; G06V 30/413

(52) U.S. Cl. CPC G06V 20/95; G06V 30/412; G06V 30/413

(57) ABSTRACT

An intelligent and multi-layered approach that uses real-time analysis to identify and confirm the authenticity and inauthenticity of bulk digital documents. Support Vector Machine (SVM) learning is implemented to perform significant attribute validations, such as barcode validation, image-specific validations, and signature validations. An SVM classifier is implemented to compare, analyze, predict the accuracy of the document (i.e., quantify the certainty of authenticity) and decision the documents as either valid/authentic or invalid/tampered-state. Neuro-symbolic Artificial Intelligence (AI) technology is subsequently implemented to confirm or deny the authenticity decision resulting from the SVM classifier.

### FIELD OF THE INVENTION

The present invention is generally directed to digital document security and, more specifically, processing of batches of digital document through implementation of Support Vector Machine (SVM) learning techniques and neuro-symbolic AI to identify and confirm documents as being either valid/original or invalid/altered.

### BACKGROUND

Document tampering involves duplication and/or forgery of official documents in attempt to bypass legal authorities and/or approval processes. In this regard, wrongdoers can completely change or partially alter a document, which can lead to digital document tampering. Digital document tampering may include, but is not limited to, forged documents, false invoices, generation of fake/imitation documents (e.g., identification cards, passports, driver's licenses and the like), altered/camouflaged documents, and the like.

Certain entities, such as resource providers or the like, are tasked with verifying the authenticity of specific documents on an ongoing basis. For example, a resource provider must be able to constantly (i.e., in bulk) verify the authenticity of so-called proof documents, which serve as evidence or validation of a particular transaction, agreement or legal status. Since such authenticity validation of documents is germane to the very essence of a resource provider's endeavors, the process is not only critical but also must be handled in an accurate and timely fashion.

Therefore, a need exists to create a comprehensive and intelligent means whereby digital documents can be verified for their authenticity in a bulk processing manner. In this regard, the desired systems, computerized-methods, and the like should be capable of readily identifying and confirm tampered documents, such as forged documents, fake/imitation documents altered/camouflaged documents, and the like.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing a comprehensive and intelligent system for identifying and confirming the authenticity and inauthenticity (i.e., tampered state) of digital documents. This system employs a multi-layered approach, using real-time analysis to dynamically assess, in bulk, the authenticity of digital documents.

Specifically, the present invention relies on Support Vector Machine (SVM), which is a supervised learning technique to perform significant attribute validations, such as barcode validation, image-specific validations, and signature validations. In addition, an SVM classifier is implemented to compare, analyze, predict the accuracy of the document (i.e., quantify the certainty of authenticity) based, at least, on the results of the SVM-based barcode, image-specific and signature validations.

Additionally, neuro-symbolic Artificial Intelligence (AI) technology is implemented to confirm or deny the authenticity decision resulting from the SVM classifier. Neuro-symbolic AI allows for analyzing the documents based on both logical/human intelligence-like reasoning (i.e., symbolic reasoning) and a knowledge base (i.e., learned neural network).

In specific embodiments of the invention, metadata extraction and analysis is used to extract relevant metadata from the digital documents that is used to determine whether a document has been tampered with. In other specific embodiments of the invention, intelligent document processing that relies on AI and, specifically Machine Learning (ML) techniques is used classify the digital documents, extract relevant data from the documents and apply classification-specific rules to assess whether the document is authentic or may have been tampered with. Such classification specific rules may be pattern-based rules (e.g., alignment of the document), dictionary-based rules (e.g., spelling/grammar of text in the document), context-based rules (e.g., purpose of the document) and/or custom rules. In such embodiments of the invention, both the metadata analysis results and the intelligent document processing results may be used by that SVM classifier as a further basis for predicting the accuracy of the document (i.e., quantifying the certainty of authenticity).

A system for identification of digital document tampering defines first embodiments of the invention. The system includes a first computing platform having a first memory and one or more first computing processor devices in communication with the first memory. First memory stores a Support Vector Machine (SVM) platform that includes one or more SVM algorithms, which are executable by at least one of the first computing processor device(s). The SVM platform includes a digital document authenticity validation engine configured to receive a batch of digital documents. Further, the digital document authenticity validation engine is configured to implement at least one of the SVM algorithm(s) to verify authenticity of barcodes present within one or more of the digital documents. In addition, the digital document authenticity validation engine is configured to implement at least one of the SVM algorithm(s) including at least one image classifier model to classify images present within one or more of the digital documents in the batch of digital documents and verify authenticity of the images. Moreover, the digital document authenticity validation engine is configured to implement at least one of the SVM algorithm(s) to verify authenticity of signatures provided by a signatory and present within one or more of the digital documents in the batch of digital documents.

The SVM platform further includes a SVM document classifier that is configured to receive results of barcode, image and signature authenticity validation from the digital document authenticity validation engine, and implement at least one of the SVM algorithm(s) to classify each digital document in the batch of digital documents as (i) valid document or (ii) invalid document based, at least, on the results of barcode, image and signature authenticity validation.

The system additionally includes a second computing platform having a second memory, and one or more second computing processor devices in communication with the second memory. Second memory stores a neuro-symbolic Artificial Intelligence (AI) analyzer that is executable by at least one of the second computing processor device(s). Neuro-symbolic AI analyzer is configured to perform symbolic logical reasoning based at least on expert knowledge and neural network analysis to verify, for each digital document in the batch of documents, a correctness of (i) the valid document or (ii) the invalid document classification rendered by the SVM document classifier.

In specific embodiments the system further includes a third computing platform having a third memory and one or more third computing processor devices in communication with the third memory. Third memory stores a metadata extractor and analyzer that is executable by at least one of the third computing processor device(s). Metadata extractor and analyzer is configured to receive the batch of documents, and extract metadata from each digital document in the batch of documents including document creation date, any document modification date, and any modified document parameters. In response to extraction, metadata extractor and analyzer is configured to analysis the extracted metadata to determine for one or more the digital documents in the batch of digital documents that the document creation date and the document modification date are (i) a same date or (ii) different dates, and communicate extracted metadata and results of extracted metadata analysis to the SVM platform. In such embodiments of the system, the SVM document classifier is further configured to implement the at least one of the one or more SVM algorithms to classify each digital document in the batch of digital documents as (i) valid document or (ii) invalid document based further on the extracted metadata and the results of extracted metadata analysis.

In other specific embodiments the system includes a third computing platform having a third memory and one or more third computing processor devices in communication with the third memory. Third memory stores an intelligent document processing (IDP) engine that is executable by at least one of the third computing processor device(s). IDP is configured to receive the batch of documents, capture an image of each digital document in the batch of documents, and implement Artificial Intelligence (AI) including Machine Learning (ML) on the captured image to classify each digital document and extract data from each digital document in the batch of documents based on the classification. Further, IDP engine is configured to implement a rules engine to verify authenticity of each digital document in the batch documents by applying classification-specific rules to the extracted data and communicate results of document authenticity validation to the SVM platform. In such embodiments of the system, the SVM document classifier is further configured to implement the at least one of the one or more SVM algorithms to classify each digital document in the batch of digital documents as (i) valid document or (ii) invalid document is based further on the results of document authenticity validation performed by the intelligent document processing engine. In related embodiments of the system, the classification-specific rules are based on at least one of (i) text spelling, (ii) font style, (iii) font size, (iv) color, (v) alignment, and (vi) clarity.

In further specific embodiments of the system, the digital document authenticity validation engine is further configured to verify authenticity of the barcodes by detecting at least one barcode in one or more of the digital documents in the batch of digital documents, extracting the at least one barcode from the one or more of the digital documents in the batch of digital documents, and verifying (i) a pattern of the least one barcode and (ii) a position of the least one barcode. The pattern and position of the least one barcode are specific to a document type.

In other specific embodiments of the system, the digital document authenticity validation engine is further configured to verify authenticity of the images by detecting at least one image in one or more of the digital documents in the batch of digital documents, extracting the at least one image from the one or more of the digital documents in the batch of digital documents, and verifying (i) alignment of the least one image and (ii) position of the least one image, (iii) size of the least image in comparison to a known reference image. The alignment, position, and size of the least one image are specific to the image classification.

In still further specific embodiments of the system, the digital document authenticity validation engine is further configured to verify authenticity of the signatures by detect at least one signature (i.e., (i) a physical signature, or (ii) an electronic signature (e-signature)) in one or more of the digital documents in the batch of digital documents, extracting at least one signature from the one or more of the digital documents in the batch of digital documents, and verify at least one of (i) shape of the least one signature, (ii) smoothness of the least of signature, and (iii) line thickness of the least one signature in comparison to a known reference signature.

Moreover, in additional specific embodiments of the system the SVM document classifier is configured to classify each digital document in the batch of digital documents as (i) valid document or (ii) invalid document by assigning a validity value to each digital document based at least, on the results of barcode, image and signature authenticity validation, comparing each of the validity values to a corresponding predetermined validity threshold value, which is based on document type, and classifying each documents in the batch of digital documents as (i) valid document based on the validity value being at or above the corresponding predetermined validity threshold value and (ii) invalid document based on the validity value being below the corresponding predetermined validity threshold value.

A computer-implemented method for identification of document tampering defines second embodiments of the invention. The computer-implemented method is executable by one or more computing processor devices. The method includes receiving a batch of digital documents, implementing at least one Support Vector Machine (SVM) algorithm to verify authenticity of barcodes present within one or more of the digital documents in the batch of digital documents, implementing at least one SVM algorithm including at least one image classifier model to classify images present within one or more of the digital documents in the batch of digital documents and verify authenticity of the images and implementing at least one SVM algorithm to verify authenticity of signatures provided by a signatory and present within one or more of the digital documents in the batch of digital documents. The method further includes implementing at least one SVM algorithm to classify each digital document in the batch of digital documents as (i) valid document or (ii) invalid document based, at least, on the results of barcode, image and signature authenticity validation, and implementing neuro-symbolic Artificial Intelligence (AI) to perform symbolic logical reasoning based at least on expert knowledge and neural network analysis to verify, for each digital document in the batch of documents, a correctness of (i) the valid document or (ii) the invalid document classification.

In specific embodiments the computer-implemented method further includes extracting metadata from each digital document in the batch of documents including document creation date, any document modification date and any modified document parameters, and analyzing the extracted metadata to determine for one or more the digital documents in the batch of digital documents that the document creation date and the document modification date are (i) a same date or (ii) different dates. In such embodiments of the method, implementing the at least one SVM algorithm to classify each digital document in the batch of digital documents as (i) valid document or (ii) invalid document is based further on the extracted metadata and the results of extracted metadata analysis.

In other specific embodiments the computer-implemented method further includes capturing an image of each digital document in the batch of documents, implementing Artificial Intelligence (AI) including Machine Learning (ML) on the captured image to classify each digital document and extract data from each digital document in the batch of documents based on the classification, and implementing a rules engine to verify authenticity of each digital document in the batch documents by applying classification-specific rules to the extracted data. In such embodiments of the method, implementing the at least one SVM algorithm to classify each digital document in the batch of digital documents as (i) valid document or (ii) invalid document is based further on the results of document authenticity validation performed by the intelligent document processing engine. In specific related embodiments of the computer-implemented method, the classification-specific rules are based on at least one of (i) text spelling, (ii) font style, (iii) font size, (iv) color, (v) alignment, and (vi) clarity.

In still further specific embodiments of the computer-implemented method, implementing the at least one SVM algorithm to verify authenticity of barcodes further includes detecting at least one barcode in one or more of the digital documents in the batch of digital documents, extracting the at least one barcode from the one or more of the digital documents in the batch of digital documents, and verifying (i) a pattern of the least one barcode and (ii) a position of the least one barcode, wherein the pattern and position of the least one barcode are specific to a document type.

In additional specific embodiments of the computer-implemented method, implementing the at least one SVM algorithm to verify authenticity of the images further includes detecting at least one image in one or more of the digital documents in the batch of digital documents, extracting the at least one image from the one or more of the digital documents, and verifying (i) alignment of the least one image and (ii) position of the least one image, (iii) size of the least image in comparison to a known reference image, wherein the alignment, position and size of the least one image are specific to the image classification.

In still further specific embodiments of the computer-implemented method, implementing the at least one SVM algorithm to verify authenticity of signatures further includes detecting at least one signature (i.e., (i) a physical signature, or (ii) an electronic signature (e-signature)) in one or more of the digital documents in the batch of digital documents, extracting at least one signature from the one or more of the digital documents, and verifying at least one of (i) shape of the least one signature, (ii) smoothness of the least of signature, and (iii) line thickness of the least one signature in comparison to a known reference signature.

A computer program product including a non-transitory computer-readable medium defines third embodiments of the invention. The non-transitory computer-readable medium includes a first set of codes for causing a computing device to receive a batch of digital documents and a second set of codes for causing a computing device to implement at least one Support Vector Machine (SVM) algorithm to verify authenticity of barcodes present within one or more of the digital documents in the batch of digital documents. The computer-readable medium additionally includes a third set of codes for causing a computing device to implement at least one SVM algorithm including at least one image classifier model to classify images present within one or more of the digital documents in the batch of digital documents and verify authenticity of the images and a fourth set of codes for causing a computing device to implement at least one SVM algorithm to verify authenticity of signatures provided by a signatory and present within one or more of the digital documents in the batch of digital documents. Moreover, the computer-readable medium additionally includes a fifth set of codes for causing a computing device to implement at least one SVM algorithm to classify each digital document in the batch of digital documents as (i) valid document or (ii) invalid document based, at least, on the results of barcode, image and signature authenticity validation, and a sixth set of codes for causing a computing device to implement neuro-symbolic Artificial Intelligence (AI) to perform symbolic logical reasoning based at least on expert knowledge and neural network analysis to verify, for each digital document in the batch of documents, a correctness of (i) the valid document or (ii) the invalid document classification.

In specific embodiments of the computer program product, the computer-readable medium further includes a seventh set of codes for causing a computing device to extract metadata from each digital document in the batch of documents including document creation date, any document modification date and any modified document parameters, and an eighth set of codes for causing a computing device to analyze the extracted metadata to determine for one or more the digital documents in the batch of digital documents that the document creation date and the document modification date are (i) a same date or (ii) different dates. In such embodiments of the computer program product, the fifth set of codes are further configured to cause the computing device to implement the at least one SVM algorithm to classify each digital document in the batch of digital documents as (i) valid document or (ii) invalid document is based further on the extracted metadata and the results of extracted metadata analysis.

In other specific embodiments of the computer program product, the computer-readable medium further includes a seventh set of codes for causing a computing device to capture an image of each digital document in the batch of documents, an eighth set of codes for causing a computer device to implement Artificial Intelligence (AI) including Machine Learning (ML) on the captured image to classify each digital document and extract data from each digital document in the batch of documents based on the classification, and a ninth set of codes for causing a computing device to implement a rules engine to verify authenticity of each digital document in the batch documents by applying classification-specific rules to the extracted data. In such embodiments of the computer program product, the fifth set of codes are further configured to cause the computing device to implement the at least one SVM algorithm to classify each digital document in the batch of digital documents as (i) valid document or (ii) invalid document is based further on the results of document authenticity validation performed by the intelligent document processing engine. In related further specific embodiments of the computer program product, the classification-specific rules are based on at least one of (i) text spelling, (ii) font style, (iii) font size, (iv) color, (v) alignment, and (vi) clarity.

Moreover, in additional specific embodiments of the computer program product, the second set of codes are further configured to cause the computer to (i) detect at least one barcode in one or more of the digital documents in the batch of digital documents, (ii) extract the at least one barcode from the one or more of the digital documents in the batch of digital documents, and (iii) verify (a) a pattern of the least one barcode and (b) a position of the least one barcode, wherein the pattern and position of the least one barcode are specific to a document type. The third set of codes are further configured to cause the computer to (i) detect at least one image in one or more of the digital documents in the batch of digital documents, (ii) extract the at least one image from the one or more of the digital documents in the batch of digital documents, and (iii) verifying (a) alignment of the least one image and (b) position of the least one image, and (c) size of the least image in comparison to a known reference image, wherein the alignment, position and size of the least one image are specific to the image classification. The fourth set of codes are further configured to cause the computer to (i) detect at least one signature in one or more of the digital documents in the batch of digital documents, wherein the at least signature comprises (a) a physical signature, or (b) an electronic signature (e-signature), (ii) extract at least one signature from the one or more of the digital documents in the batch of digital documents, and (iii) verifying at least one of (a) shape of the least one signature, (b) smoothness of the least of signature, and (c) line thickness of the least one signature in comparison to a known reference signature.

Thus, according to embodiments of the invention, which will be discussed in greater detail below, the present invention addresses needs and/or achieves other advantages by providing for an intelligent and multi-layered approach that uses real-time analysis to identify and confirm the authenticity and inauthenticity (i.e., tampering) of bulk digital documents. Specifically, support Vector Machine (SVM) learning is implemented to perform significant attribute validations, such as barcode validation, image-specific validations, and signature validations. An SVM classifier is implemented to compare, analyze, predict the accuracy of the document (i.e., quantify the certainty of authenticity) and decision the documents as either valid/authentic or invalid/tampered-state. Neuro-symbolic Artificial Intelligence (AI) technology is subsequently implemented to confirm or deny the authenticity decision resulting from the SVM classifier.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for identification of digital document tampering using Support Vector Machine (SVM) learning techniques and neuro-symbolic Artificial Intelligence (AI) analysis, in accordance with embodiments of the present invention;

FIG. 2 is a schematic/block diagram of a system for identification of digital document tampering using SVM learning techniques, neuro-symbolic AI analysis and metadata extraction and analysis, in accordance with alternate embodiments of the present invention;

FIG. 3 is a schematic/block diagram of a system for identification of digital document tampering using SVM learning techniques, neuro-symbolic AI analysis and an intelligent document processing (IDP) engine, in accordance with embodiments of the present invention;

FIG. 4 is a block/flow diagram of processing occurring within a SVM learning platform and neuro-symbolic AI analyzer, in accordance with embodiments of the invention;

FIG. 5 is a block/flow diagram of processing occurring within a metadata extractor and analyzer, IDP engine, a SVM learning platform and neuro-symbolic AI analyzer, in accordance with embodiments of the invention;

FIG. 6 is a block/flow diagram of processing occurring within a metadata extractor and analyzer, in accordance with alternate embodiments of the present invention;

FIG. 7 is a block/flow diagram of processing occurring within an IDP engine, in accordance with embodiments of the present invention;

FIG. 8 is a block/flow diagram of processing occurring within SVM-based barcode authenticity validation, in accordance with embodiments of the present invention;

FIG. 9 is a block/flow diagram of processing occurring within SVM-based image authenticity validation, in accordance with embodiments of the present invention;

FIG. 10 is a block/flow diagram of processing occurring within SVM-based signature authenticity validation, in accordance with embodiments of the present invention; and

FIG. 11 is a flow diagram of a method for identification of digital document tampering using Support Vector Machine (SVM) learning techniques and neuro-symbolic Artificial Intelligence (AI) analysis, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for a comprehensive and intelligent system for identifying and confirming the authenticity and inauthenticity (i.e., tampered state) of digital documents. This system employs a multi-layered approach, using real-time analysis to dynamically assess, in bulk, the authenticity of digital documents.

Specifically, the present invention relies on Support Vector Machine (SVM), which is a supervised learning technique to perform significant attribute validations, such as barcode validation, image-specific validations, and signature validations. In addition, an SVM classifier is implemented to compare, analyze, predict the accuracy of the document (i.e., quantify the certainty of authenticity) based, at least, on the results of the SVM-based barcode, image-specific and signature validations.

Additionally, neuro-symbolic Artificial Intelligence (AI) technology is implemented to confirm or deny the authenticity decision resulting from the SVM classifier. Neuro-symbolic AI allows for analyzing the documents based on both logical/human intelligence-like reasoning (i.e., symbolic reasoning) and a knowledge base (i.e., learned neural network).

In specific embodiments of the invention, metadata extraction and analysis is used to extract relevant metadata from the digital documents that is used to determine whether a document has been tampered with. In other specific embodiments of the invention, intelligent document processing that relies on AI and, specifically Machine Learning (ML) techniques is used classify the digital documents, extract relevant data from the documents and apply classification-specific rules to assess whether the document is authentic or may have been tampered with. Such classification specific rules may be pattern-based rules (e.g., alignment of the document), dictionary-based rules (e.g., spelling/grammar of text in the document), context-based rules (e.g., purpose of the document) and/or custom rules. In such embodiments of the invention, both the metadata analysis results and the intelligent document processing results may be used by that SVM classifier as a further basis for predicting the accuracy of the document (i.e., quantifying the certainty of authenticity).

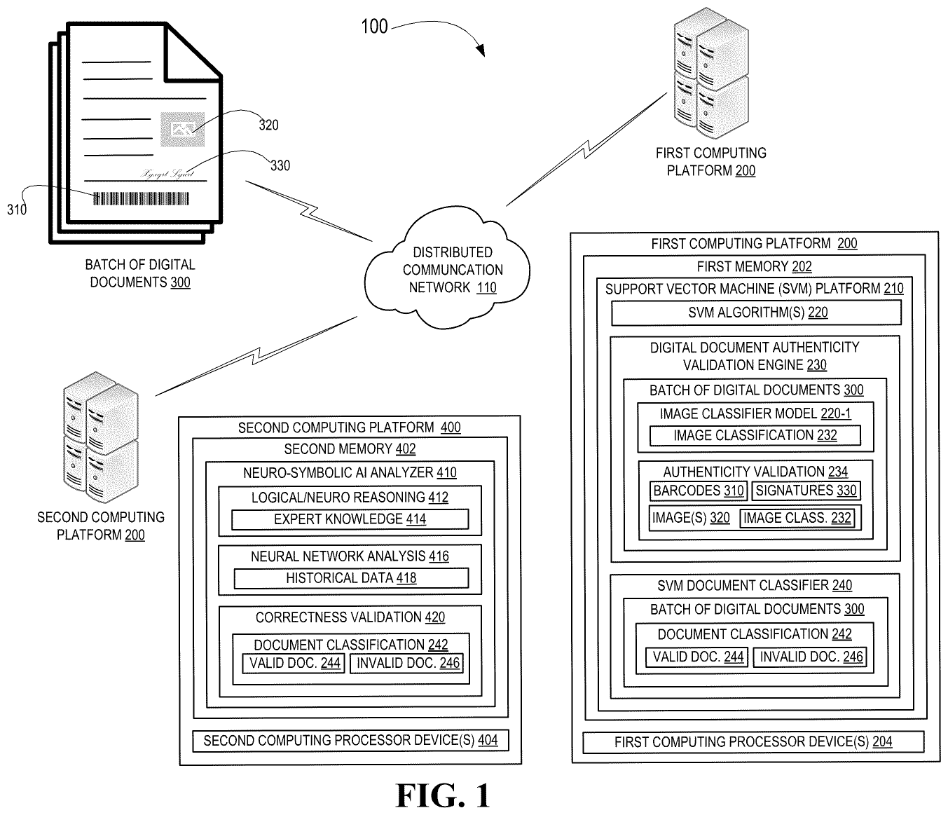

Referring to FIG. 1, a schematic/block diagram is presented of an exemplary system 100 for digital document tampering identification, in accordance with embodiments of the present invention. The system 100 is implemented across a distributed communication network 110, such as the Intranet, one or more intranets or the like. “Tampering” as used herein may refer to forged documents, including invoice malfeasance, blank documents, camouflaged documents, imitation documents and the like.

System 100 includes first computing platform 200, which may comprise one or more servers or the like. First computing platform 200 includes first memory 202 and one or more first computing processor devices 204 in communication with first memory 202. First memory 202 may comprise volatile and non-volatile memory, such as read-only memory (ROM) and/or random-access memory (RAM), EPROM, EEPROM, flash cards, or any memory common to computer platforms. Moreover, first memory 202 may comprise cloud storage, such as provided by a cloud storage service and/or a cloud connection service. First computing process device(s) 204 may be an application-specific integrated circuit (“ASIC”), or other chipset, logic circuit, or other data processor device. First computing processor device(s) 204 may execute an application programming interface (“API”) (not shown in FIG. 1) that interfaces with any resident programs, such as SVM platform 210 and algorithms, sub-engines/routines associated therewith or the like stored in the first memory 202 of first computing platform 200.

First memory 202 stores support vector machine (SVM) platform 210 that includes one or more SVM algorithms 220 and is executable by at least one of the one or more first computing processor devices 204.

As known by those of ordinary skill in the art, SVM is a supervised machine learning algorithm used for classification and regression tasks. SVM functions by finding the hyperplane that best separates classes in the feature space, maximizing the margin between classes. SVM aims to find the optimal decision boundary that maximizes the margin while minimizing classification error and can handle linear and nonlinear classification tasks through the use of different kernel functions.

SVM platform 210 includes a digital document authenticity validation engine 230 that is configured to receive (e.g., upload) a batch of digital documents 300. A batch, as used herein, may include any number of documents, typically hundreds to thousands of digital documents. In one specific example, in which the batch of digital documents is submitted or otherwise controlled by a financial institution the digital documents may include documents required for loan processing (e.g., financial institution statements, driver's license, passport, other legal documents and the like), checks or any other documents requiring a check for authenticity and, in some embodiments, accuracy. As such, individual digital documents within the batch may include, but are not required to include a barcode(s) 310, image(s) 320, and signatures(s) 330.

In response to receiving the batch of digital documents, digital document authenticity validation engine 230 implements one or more of the SVM algorithms 220 including one or more image classifier models 220-1 to perform image classification 232 on the images 320 (e.g., logos, photographs, and the like) present within the digital documents 300. In response to classifying the images 320, digital document authenticity validation engine 230 implements one or more of the SVM algorithms 220 to perform authenticity validation 234 on the images 320 based, at least on the classification 232. Validation 234 of the images 320 may include, but is not limited to, verifying that the images 234 are correctly sized, positioned and properly formatted.

In addition, digital document authenticity validation engine 230 implements one or more of the SVM algorithms 220 to perform authenticity validation 234 on the barcodes 310 present within the digital documents 300. Validation 234 of the barcodes 310 may include, but is not limited to, verifying that the barcode 310 is properly positioned/aligned and verifying the correct pattern. Moreover, digital document authenticity validation engine 230 implements one or more of the SVM algorithms 220 to perform authenticity validation 234 on the signatures 330 (i.e., physical signatures or electronic signatures/e-signatures) provided by a signatory on the digital documents 300. Validation 234 of the barcodes 310 may include, but is not limited to, verifying the shape, smoothness, curvature of the signature 330 is comparison to a known reference signature of the signatory.

SVM platform additionally includes SVM document classifier 240 that is configured to receive the results from the barcode 310, image 320 and signature 330 authenticity validation 234 from the digital document authenticity validation engine 230 and, based on the results, implement one or more of the SVM algorithms 220 to perform document classification 242 on each digital document in the batch of digital documents 300. Document classification 242 includes classifying a document as either (i) a valid/authentic document 244, or (ii) an invalid/tampered-state document 246. In specific embodiments of the invention, SVM document classifier 240 is configured to quantify/score the validity of the document and compare the quantification/score to a predetermined threshold quantification/score to determine whether the document is (i) a valid/authentic document 244, or (ii) an invalid/tampered-state document 246.

System 100 additionally includes second computing platform 400, which may comprise one or more computing devices, such as servers or the like. Second computing platform 400 may include some and, in specific embodiments, all of the same computing devices/servers as first computing platform 200. As such, second computing platform 400 and first computing platform 200 may one and the same (i.e., the functionality described in relation to second computing platform 400 may wholly be performed with first computing platform 200).

Second computing platform 400 includes second memory 402 and one or more second computing processor devices 404 in communication with second memory 402. Second memory 402 may comprise volatile and non-volatile memory, such as read-only memory (ROM) and/or random-access memory (RAM), EPROM, EEPROM, flash cards, or any memory common to computer platforms. Moreover, second memory 402 may comprise cloud storage, such as provided by a cloud storage service and/or a cloud connection service. Second computing process device(s) 404 may be an application-specific integrated circuit (“ASIC”), or other chipset, logic circuit, or other data processor device. Second computing processor device(s) 404 may execute an application programming interface (“API”) (not shown in FIG. 1) that interfaces with any resident programs, such as neuro-symbolic AI analyzer 410 and algorithms, sub-engines/routines associated therewith or the like stored in the second memory 402 of second computing platform 400.

Second memory 402 stores neuro-symbolic AI analyzer 410 that is executable by at least one of the one or more second computing processor devices 204. Neuro-symbolic AI analyzer 410 is configured to perform logical (i.e., symbolic) reasoning 412 based on expert knowledge 414 and neural network analysis 416 based on historical data 418 to perform correctness validation 420, for each digital document 300 in the batch, to verify the correctness of the document classification 242. In this regard, neuro-symbolic AI analyzer 410 is configured the correctness of (i) a valid/authentic document 244 classification, or (ii) an invalid/tampered-state document 246 classification rendered by the SVM document classifier 240.

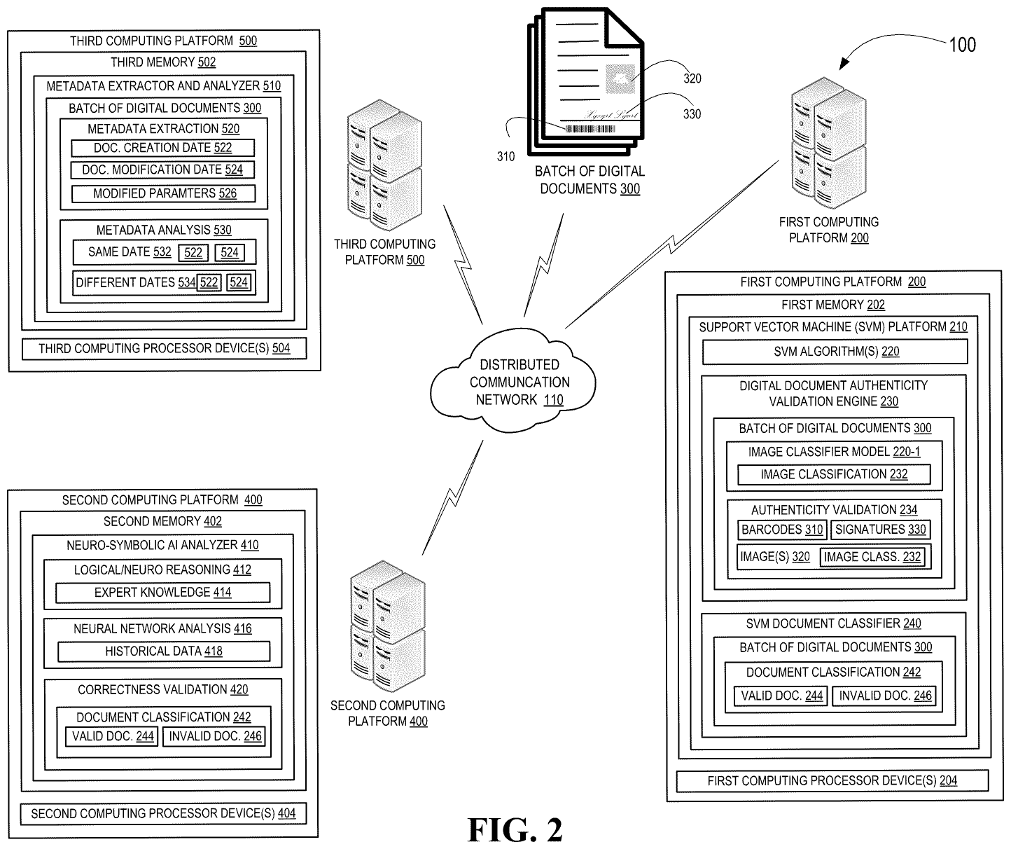

Referring to FIG. 2, a block diagram is depicted of an alternative embodiment of system 100 for digital document tampering identification, in accordance with embodiments of the present invention. The system includes the same SVM platform 210 and neuro-symbolic AI analyzer 410 as described in relation to the system 100 shown in FIG. 1 and, therefore, for the sake of brevity, first and second computing platforms 200, 400 will not be described in relation to FIG. 2.

System 100 of FIG. 2 includes third computing platform 500, which may comprise one or more computing devices, such as servers or the like. Third computing platform 500 may include some and, in specific embodiments, all of the same computing devices/servers as first computing platform 200 and/or second computing platform 400. As such, third computing platform 500 and first computing platform 200 and/or second computing platform 400 may one and the same (i.e., the functionality described in relation to third computing platform 500 may wholly be performed with first computing platform 200 and/or second computing platform 400).

Third computing platform 500 includes third memory 502 and one or more third computing processor devices 504 in communication with third memory 502. Third memory 502 may comprise volatile and non-volatile memory, such as read-only memory (ROM) and/or random-access memory (RAM), EPROM, EEPROM, flash cards, or any memory common to computer platforms. Moreover, third memory 502 may comprise cloud storage, such as provided by a cloud storage service and/or a cloud connection service. Third computing process device(s) 504 may be an application-specific integrated circuit (“ASIC”), or other chipset, logic circuit, or other data processor device. Third computing processor device(s) 504 may execute an application programming interface (“API”) (not shown in FIG. 2) that interfaces with any resident programs, such as metadata extractor and analyzer 510 and algorithms, sub-engines/routines associated therewith or the like stored in the third memory 502 of third computing platform 500.

Third memory 502 stores metadata extractor and analyzer 510 that is configured to initially receive the batch of digital documents 300 (i.e., prior to the batch of digital documents 300 being received by the SVM platform 210 of first computing platform 200) and perform metadata extraction 502 on each of the documents in the batch of digital documents 300. Metadata extraction includes extracting relevant/predetermined metadata, such as, but not limited to, document creation date 522, and, where applicable, document modification date 524 and modified parameters/data fields 526.

In response to metadata extraction 520, metadata extractor and analyzer 510 is further configured to perform requisite analysis on the metadata. The analysis may include, but is not limited to, determine whether the document creation date 522 and any modification date(s) is/are the same date 532 or a different date 534. In response to metadata analysis, the results are communicated to the SVM document classifier 240 and, in some embodiments, neuro-symbolic AI analyzer 410 and serve as the basis for document classification 242 and, in some embodiments, correctness validation 420.

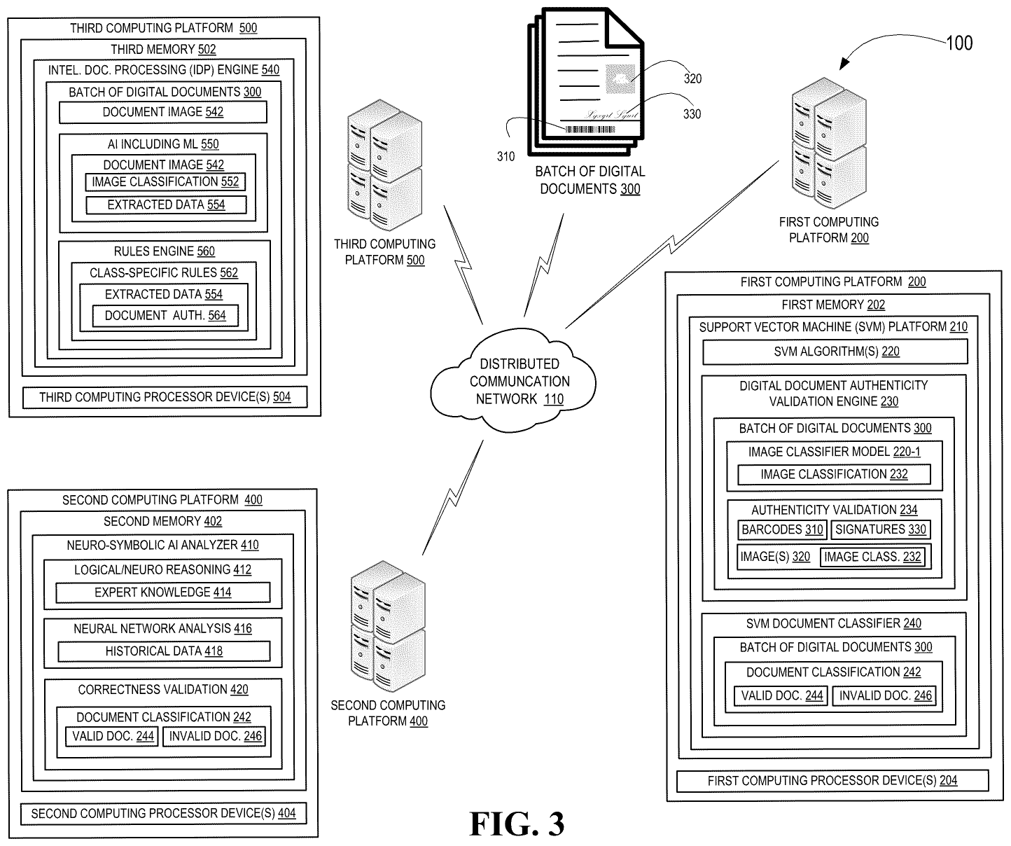

Referring to FIG. 3, a block diagram is depicted of an alternative embodiment of system 100 for digital document tampering identification, in accordance with embodiments of the present invention. The system includes the same SVM platform 210 and neuro-symbolic AI analyzer 410 as described in relation to the system 100 shown in FIG. 1 and, therefore, for the sake of brevity, first and second computing platforms 200, 400 will not be described in relation to FIG. 2.

System 100 of FIG. 3 includes third computing platform 500, which may comprise one or more computing devices, such as servers or the like. Third computing platform 500 may include some and, in specific embodiments, all of the same computing devices/servers as first computing platform 200 and/or second computing platform 400. As such, third computing platform 500 and first computing platform 200 and/or second computing platform 400 may one and the same (i.e., the functionality described in relation to third computing platform 500 may wholly be performed with first computing platform 200 and/or second computing platform 400).

Third computing platform 500 includes third memory 502 and one or more third computing processor devices 504 in communication with third memory 502. Third memory 502 may comprise volatile and non-volatile memory, such as read-only memory (ROM) and/or random-access memory (RAM), EPROM, EEPROM, flash cards, or any memory common to computer platforms. Moreover, third memory 502 may comprise cloud storage, such as provided by a cloud storage service and/or a cloud connection service. Third computing process device(s) 504 may be an application-specific integrated circuit (“ASIC”), or other chipset, logic circuit, or other data processor device. Third computing processor device(s) 504 may execute an application programming interface (“API”) (not shown in FIG. 3) that interfaces with any resident programs, such as intelligent document processing engine 540 and algorithms, sub-engines/routines associated therewith or the like stored in the third memory 502 of third computing platform 500.

Third memory 502 stores intelligent document processing engine 540 that is configured to receive the batch of digital documents 300 (i.e., prior to the batch of digital documents 300 being received by the SVM platform 210 of first computing platform 200) and, in response, capture an image 542 of the entirety of each document in the batch of digital documents 300 and implement Artificial Intelligence (AI) including Machine Learning (ML) 550 on the captured image 542 to perform image classification 552 to classify the documents based on type and extract data 554 from each document in the batch of digital documents 300 based on the classification 552.

In response to data extraction 554, intelligent document processing engine 540 is configured to implement a rules engine 560 to verify authenticity 564 of each document in the batch of digital documents 300 by applying classification-specific rules 562 to the extracted data 554. In response to authenticity validation, intelligent document processing engine 540 is configured to communicate the authenticity validation 564 results to the SVM document classifier 240 and, in some embodiments, neuro-symbolic AI analyzer 410, which serve as the basis for document classification 242 and, in some embodiments, correctness validation 420.

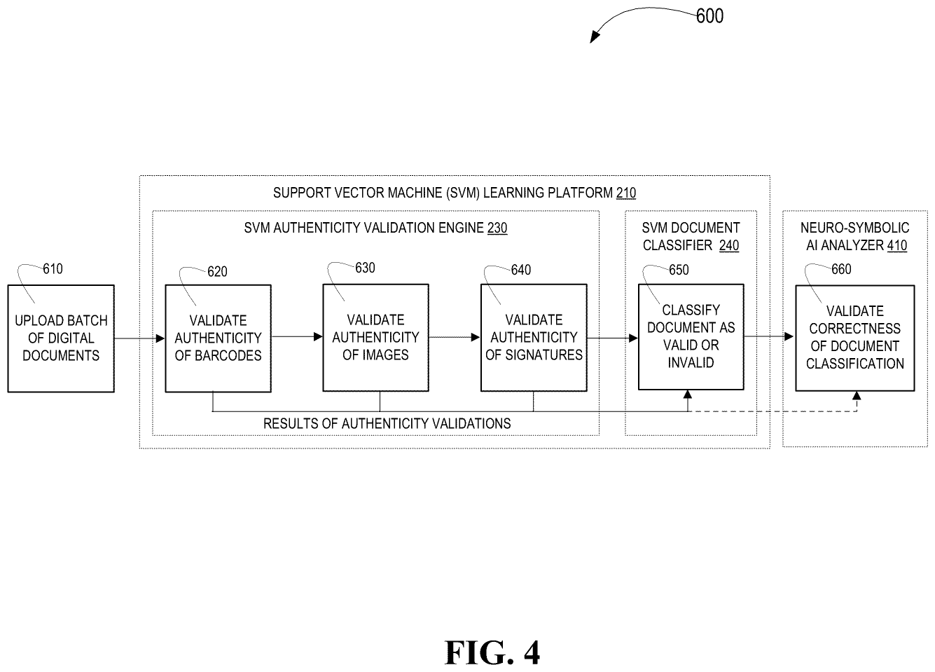

Referring to FIG. 4, a block/flow diagram is depicted, which illustrates process flow 600 for digital document tampering identification, in accordance with embodiments of the present invention. At Event 610, a batch of digital documents is uploaded to the system and, specifically, the Support Vector Machine (SVM) platform 210. As previous discussed the batch may comprise any number of documents, typically hundreds to thousands of digital documents. In one specific embodiment, in which the batch of digital documents is submitted or otherwise controlled by a financial institution the digital documents may include documents required for loan processing (e.g., financial institution statements, driver's license, passport, other legal documents and the like), checks or any other documents requiring a check for authenticity and, in some embodiments, accuracy.

In response to uploading the batch of digital documents, the SVM authenticity validation engine 230 receives the documents and, at Event 620, the authenticity of any barcodes present on the documents is validated. Validation of the authenticity of the barcodes may include, but is not limited to, validating the position/placement of the barcode, the pattern of the barcode, the clarity of the barcode and the like. In response to completing the barcode authenticity validation, the results are communicated to the SVM document classifier 240 and, in some embodiments of the invention, the neuro-symbolic AI analyzer 410.

At Event 630, the authenticity of any images present on the documents is validated. Such validation may include classifying the images (e.g., logos, photographs, and the like) prior to performing the actual authenticity validation. Validation of the authenticity of the images may include, but is not limited to, validating the position/placement of the images, the clarity of the imager, the coloring of the images, the size of the image, the format of the image and the like. In response to completing the image authenticity validation, the results are communicated to the SVM document classifier 240 and, in some embodiments of the invention, the neuro-symbolic AI analyzer 410.

At Event 640, the authenticity of any signatures present on the documents is validated. Validation of the authenticity of the signatures, including physical signatures and/or e-signatures, may include, but is not limited to, comparing the shape, smoothness/slant angles, line thickness/pen pressure or the like to a known reference signature of the signatory or the like. In response to completing the signature authenticity validation, the results are communicated to the SVM document classifier 240 and, in some embodiments of the invention, the neuro-symbolic AI analyzer 410.

One of ordinary skill in the art will appreciate that the order in which authenticity validation of barcodes (Event 620), images (Event 630) and signatures (Event 640) occur is shown by way of example only and may occur in any order and, in some embodiments of the invention, at least a portion of the authenticity validation of barcodes, images and signatures may occur in parallel.

In response to SVM authenticity validation engine completing all of the authenticity validation processing, at Event 650, SVM document classifier 240 classifies each of the documents as either (i) valid/authentic or (ii) invalid/tampered based, at least on the results of barcode, image and signature authenticity validation processing. In specific embodiments of the invention, document classification includes quantifying an authenticity validation score, which is subsequently compared to a threshold score to determine whether or not the documents is valid/authentic.

In response to completing the document classification, at Event 660, the neuro-symbolic AI analyzer 410 verifies the correctness of the document classification using expert knowledge-based logical/symbolic reasoning and historical data-based neuro network analysis.

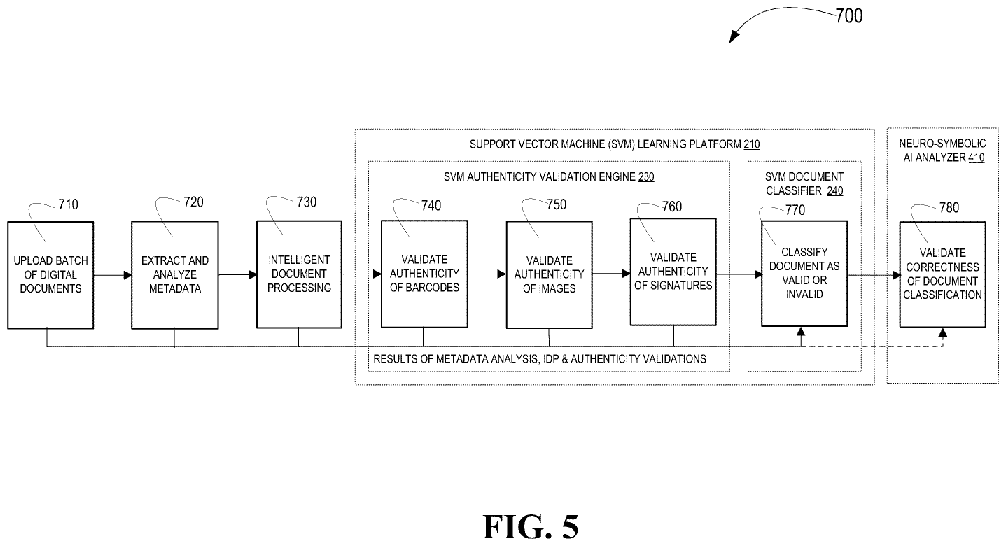

Referring to FIG. 5, a block/flow diagram is depicted, which illustrates process flow 700 for digital document tampering identification, in accordance with embodiments of the present invention. At Event 710, a batch of digital documents is uploaded to the system and, at Event 720, metadata is extracted from each of the documents and the metadata is analyzed. The extracted metadata and results of the metadata analysis are communicated to the SVM classifier and, in some embodiments of the invention, the neuro-symbolic AI analyzer 410.

In response to metadata analysis, at Event 730, each document in the batch of documents undergoes intelligent document processing during with AI/ML is implemented to extract data from the documents and a rules-based engine is implemented whereby document classification-specific rules are applied to the extracted data to validate the authenticity of the documents in whole.

One of ordinary skill in the art will appreciate that the order in which metadata extraction/analysis (Event 720) and intelligent document processing (Event 730) occur is shown by way of example only and may occur in the opposite order and, in some embodiments of the invention, at least a portion of the metadata extraction/analysis and intelligent document processing may occur in parallel.

In response to intelligent document processing, the SVM authenticity validation engine 230 receives the documents and, at Event 740, the authenticity of any barcodes present on the documents is validated. Validation of the authenticity of the barcodes may include, but is not limited to, validating the position/placement of the barcode, the pattern of the barcode, the clarity of the barcode and the like. In response to completing the barcode authenticity validation, the results are communicated to the SVM document classifier 240 and, in some embodiments of the invention, the neuro-symbolic AI analyzer 410.

At Event 7500, the authenticity of any images present on the documents is validated. Such validation may include classifying the images (i.e., logos, photographs, and the like) prior to performing the actual authenticity validation. Validation of the authenticity of the images may include, but is not limited to, validating the position/placement of the images, the clarity of the imager, the coloring of the images, the size of the image, the format of the image and the like. In response to completing the image authenticity validation, the results are communicated to the SVM document classifier 240 and, in some embodiments of the invention, the neuro-symbolic AI analyzer 410.

At Event 760, the authenticity of any signatures present on the documents is validated. Validation of the authenticity of the signatures, including physical signatures and/or e-signatures, may include, but is not limited to, comparing the shape, smoothness/slant angles, line thickness/pen pressure or the like to a known reference signature of the signatory or the like. In response to completing the signature authenticity validation, the results are communicated to the SVM document classifier 240 and, in some embodiments of the invention, the neuro-symbolic AI analyzer 410.

One of ordinary skill in the art will appreciate that the order in which authenticity validation of barcodes (Event 740), images (Event 750) and signatures (Event 760) occur is shown by way of example only and may occur in any order and, in some embodiments of the invention, at least a portion of the authenticity validation of barcodes, images and signatures may occur in parallel.

In response to SVM authenticity validation engine completing all of the authenticity validation processing, at Event 770, SVM document classifier 240 classifies each of the documents as either (i) valid/authentic or (ii) invalid/tampered based, at least on the results of metadata extraction analysis (Event 720), intelligent document processing (Event 730) and barcode (Event 740), image (Event 750) and signature authenticity (Event 760) validation processing. In specific embodiments of the invention, document classification includes quantifying an authenticity validation score, which is subsequently compared to a threshold score to determine whether or not the documents is valid/authentic.

In response to completing the document classification, at Event 780, the neuro-symbolic AI analyzer 410 verifies the correctness of the document classification using expert knowledge-based logical/symbolic reasoning and historical data-based neuro network analysis.

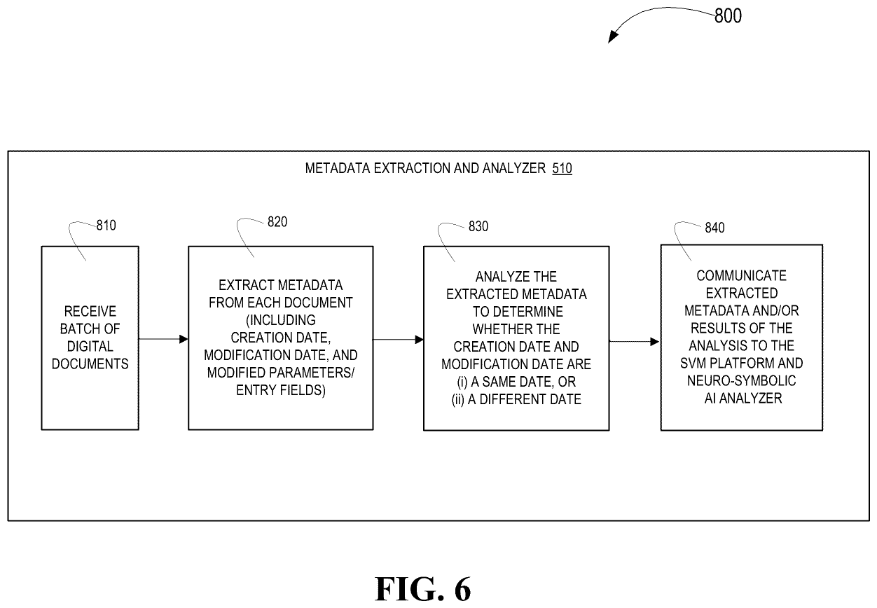

Referring to FIG. 6, a block/flow diagram is depicted which illustrates the processing flow 800 within a metadata extractor and analyzer 510 as described in relation to the system 100 shown in FIG. 2, in accordance with embodiments of the present invention. At Event 810 a batch of digital documents is received and, at Event 820, relevant metadata is extracted from each of the documents. The relevant metadata includes, but is not limited to, (i) the document creation date, (ii) any document modification date(s) and (iii) any modified parameters/entry fields.

In response to extracting the relevant metadata, at Event 830, the extracted metadata undergoes analysis. Metadata analysis includes, but is not limited to, determining whether the creation date and the modification date(s) are the (i) same date or (ii) different dates. When the creation date and the modification date are different dates, it may be indicative of document tampering. At Event 840, the extracted metadata and the results of the metadata analysis are communicated to the SVM platform and, in some embodiments of the invention, the neuro-symbolic AI analyzer.

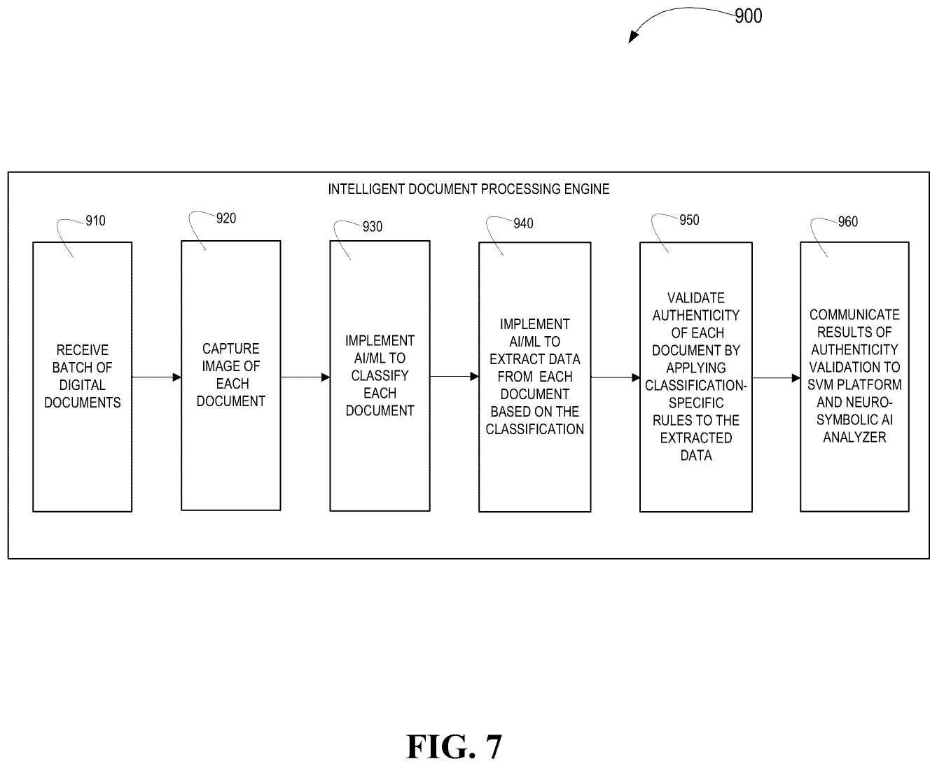

Referring to FIG. 7, a block/flow diagram is depicted which illustrates the processing flow 900 within the intelligent processing engine 540 as described in relation to the system 100 shown in FIG. 3, in accordance with embodiments of the present invention. At Event 910, a batch of digital documents is received. In specific embodiments of the invention, the batch of digital documents is received after metadata extraction/analysis and/or prior to SVM platform processing.

At Event 920, an image is captured of the entirety of each document, and at Event 930, Artificial Intelligence (AI) including Machine Learning (ML) is implemented on the captured image to classify each document. In response to classifying each document, at Event 940, AI including ML is implemented to extract data from each document based on the classification.

At Event 950, authenticity of each document is validated by applying classification specific rules to the extracted data. In specific embodiments of the invention, the specific rules are based on or otherwise related to, but not limited to, (i) spelling, grammar of text in the document, (ii) font size or style used in the document, (iii) color, shading used in the document, (iv) alignment of the document and (v) clarity of the text, images, or overall document. In response to validating the authenticity of each document, at Event 960, the results of the authenticity validation are communicated to the SVM platform and, in some embodiments of the invention, the neuro-symbolic AI analyzer.

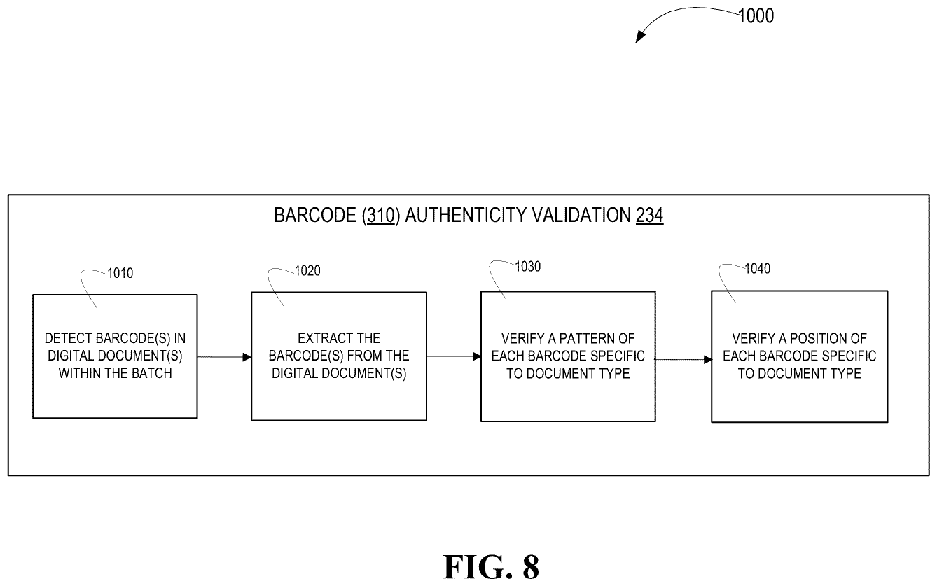

Referring to FIG. 8, a block/flow diagram is depicted which illustrates the processing flow 1000 of barcode authenticity validation, in accordance with embodiments of the present invention. At Event 1010, a barcode(s) is detected within specific documents in the batch. One of ordinary skill in the art will appreciate that not all types of digital documents undergoing tampering identification will include a barcode. In response to detecting a barcode(s), at Event 1020, the barcodes are extracted from the digital document for subsequent analysis purposes.

In response to extracting the barcode(s), at Event 1030, the pattern of the barcode(s) is analyzed/verified based on a specific document type and, at Event 1040, the positioning of the barcode(s) on the document is analyzed/verified based on specific document type. In further embodiments of the invention, other characteristics of the barcode will also be also analyzed/verified as a means for validating the authenticity of the barcodes. In response to performing all of the requisite analysis/verifications, the results are communicated to the SVM platform and, in some embodiments of the invention, the neuro-symbolic AI analyzer.

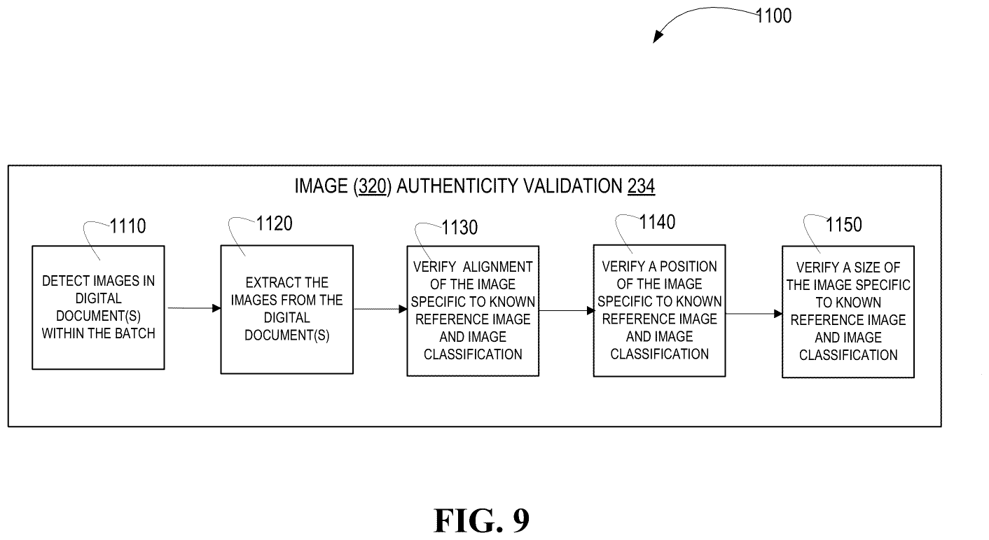

Referring to FIG. 9, a block/flow diagram is depicted which illustrates the processing flow 1100 of image authenticity validation, in accordance with embodiments of the present invention. At Event 1110, an image(s) is detected within specific documents in the batch. One of ordinary skill in the art will appreciate that not all types of digital documents undergoing tampering identification will include an image. Images may include, but are not limited to, a watermark, a logo/trademark, a photograph, a background image or the like. In response to detecting an image(s), at Event 1120, the images are extracted from the digital document for subsequent analysis purposes.

In response to extracting the image(s), at Event 1130, the alignment of the image(s) is analyzed/verified based on a specific image classification. At Event 1140, the positioning of the image(s) on the document is analyzed/verified based on image classification and, at Event 1150, the size of the image(s) is analyzed/verified based on image classification. In further embodiments of the invention, other characteristics of the image will also be also analyzed/verified as a means for validating the authenticity of the images. In response to performing all of the requisite analysis/verifications, the results are communicated to the SVM platform and, in some embodiments of the invention, the neuro-symbolic AI analyzer.

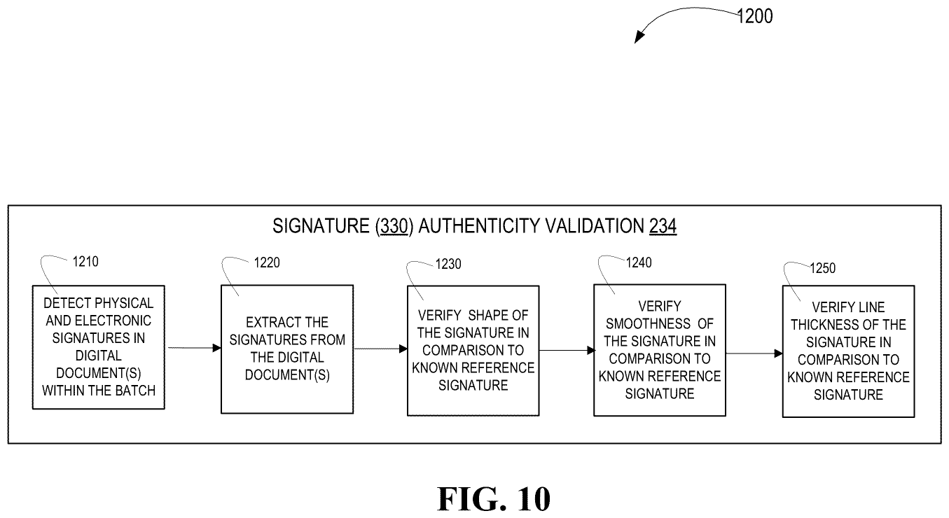

Referring to FIG. 10, a block/flow diagram is depicted which illustrates the processing flow 1200 of signature authenticity validation, in accordance with embodiments of the present invention. At Event 1210, a signature is detected within specific documents in the batch. One of ordinary skill in the art will appreciate that not all types of digital documents undergoing tampering identification will include a signature. Signatures may include, but are not limited to, physical signature or electronic/e-signatures or the like. In response to detecting a signature(s), at Event 1220, the signatures are extracted from the digital document for subsequent analysis purposes.

In response to extracting the signature(s), at Event 1230, the shape of the signature(s) is analyzed/verified in comparison to a known reference signature of the signatory. At Event 1240, the smoothness/curvature of the signature(s) on the document is analyzed/verified in comparison to a known reference signature of the signatory and, at Event 1250, the line thickness (indicative of the signatory's pen pressure) of the signature(s) on the document is analyzed/verified in comparison to a known reference signature of the signatory. In further embodiments of the invention, other characteristics of the signature will also be also analyzed/verified as a means for validating the authenticity of the signatures. In response to performing all of the requisite analysis/verifications, the results are communicated to the SVM platform and, in some embodiments of the invention, the neuro-symbolic AI analyzer.

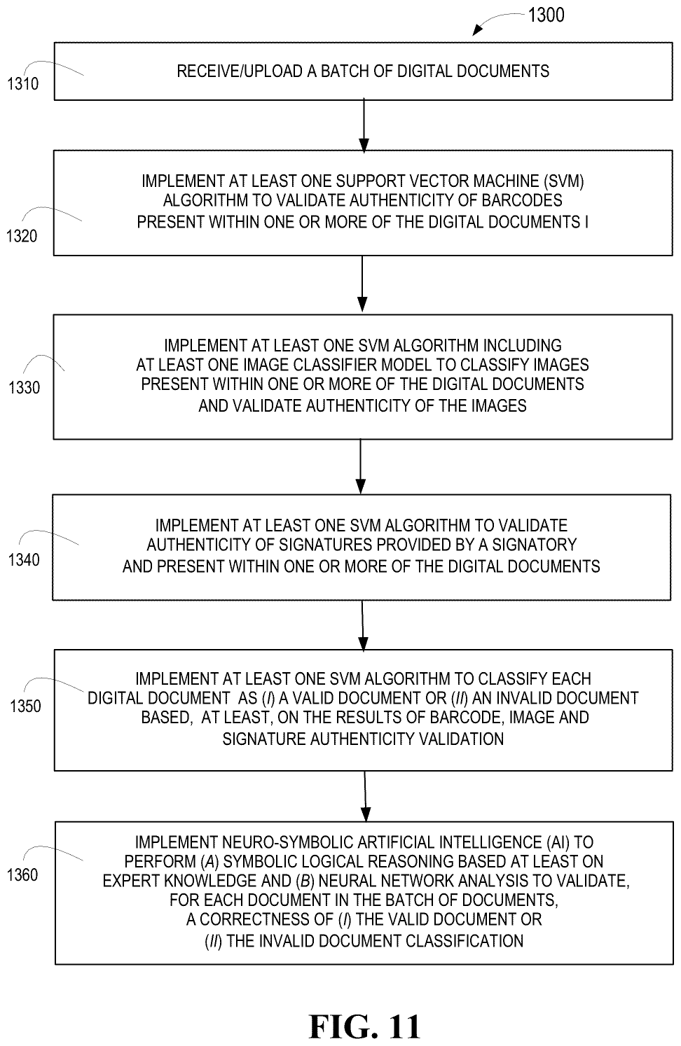

Referring to FIG. 11, a flow diagram is depicted of a computer-implemented method 1300 for identification of digital document tampering, in accordance with embodiments of the present invention. At Event 1310, a batch of digital documents is received or otherwise uploaded. As previous discussed, a batch, as used herein, may include any number of documents, typically hundreds to thousands of digital documents. In one specific example, in which the batch of digital documents is submitted or otherwise controlled by a financial institution the digital documents may include documents required for loan processing (e.g., financial institution statements, driver's license, passport, other legal documents and the like), bank notes/checks or any other documents requiring a check for authenticity and, in some embodiments, accuracy.

In optional embodiments of the method (not shown in FIG. 11), once the batch digital documents have been received/uploaded, the documents are subjected to metadata extraction and analysis and IDP (i.e., AI and ML-based validation of the authenticity of the document using a document classification-specific rules engine).

At Event 1320, at least one SVM algorithm is implemented to validate authenticity of any barcodes present on the digital document. As previously discussed, validation of the authenticity of barcodes may include, but is not limited to, verifying the correct position and/or pattern of the barcode as dictated by document type. At Event 1330, at least one SVM algorithm including an image classifier model is implemented to classify images (e.g., logos, watermarks, photographs or the like) present in the document and validate authenticity of any images present on the digital document. As previously discussed, validation of the authenticity of images may include, but is not limited to, verifying the alignment, position, coloring and/or size of the image(s) as dictated by the image classification. At Event 1340, at least one SVM algorithm is implemented to validate authenticity of any signatures present on the digital document. As previously discussed, validation of the authenticity of signatures may include, but is not limited to, verifying the shape, curvature, smoothness and/or line thickness of the signature in the document in comparison to a known reference signature of the signatory party.

At Event 1350, at least one SVM algorithm is implemented to classify each digital document as either (i) a valid/authentic document, or (ii) an invalid/tampered document with the classification based at least on the results of the barcode, image and signature authentication validations and, in some embodiments, extracted metadata and analysis and intelligent document processing (i.e., overall document authentication validation).

In response to classifying each document, at Event 1360, neuro-symbolic Artificial Intelligence (AI) is implemented to perform (i) symbolic logical reasoning based on expert knowledge and (ii) neural network analysis trained on historical data to verify/validate a correctness of the document classification. In the event that the correctness is determined to be incorrect, further human intervention may be taken to determine whether the document can or can not be authenticated/validated.

Thus, as described in detail above, present embodiments of the invention include systems, methods, computer program products and/or the like for an intelligent and multi-layered approach that uses real-time analysis to identify and confirm the authenticity and inauthenticity (i.e., tampering) of bulk digital documents. Specifically, support Vector Machine (SVM) learning is implemented to perform significant attribute validations, such as barcode validation, image-specific validations, and signature validations. An SVM classifier is implemented to compare, analyze, predict the accuracy of the document (i.e., quantify the certainty of authenticity) and decision the documents as either valid/authentic or invalid/tampered-state. Neuro-symbolic Artificial Intelligence (AI) technology is subsequently implemented to confirm or deny the authenticity decision resulting from the SVM classifier.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for identification of digital document tampering, the system comprising:
a first computing platform including a first memory, and one or more first computing processor devices in communication with the first memory, wherein the first memory stores a Support Vector Machine (SVM) platform comprising one or more SVM algorithms, executable by at least one of the one or more first computing processor devices and including:
a digital document authenticity validation engine configured to:
receive a batch of digital documents,
implement at least one of the one or more SVM algorithms to verify authenticity of barcodes present within one or more of the digital documents in the batch of digital documents,
implement at least one of the one or more SVM algorithms including at least one image classifier model to classify images present within one or
more of the digital documents in the batch of digital documents and verify authenticity of the images,
implement at least one of the one or more SVM algorithms to verify authenticity of signatures provided by a signatory and present within one or more of the digital documents in the batch of digital documents, and
a SVM document classifier configured to:
receive results of barcode, image, and signature authenticity validation from the digital document authenticity validation engine, and
implement at least one of the one or more SVM algorithms to classify each digital document in the batch of digital documents as (i) valid document or (ii) invalid document based, at least, on the results of barcode, image, and signature authenticity validation; and
a second computing platform including a second memory, and one or more second computing processor devices in communication with the second memory, wherein the second memory stores a neuro-symbolic Artificial Intelligence (AI) analyzer executable by at least one of the one or more second computing processor devices and configured to:
perform symbolic logical reasoning based at least on expert knowledge and neural network analysis to verify, for each digital document in the batch of documents, a correctness of (i) the valid document or (ii) the invalid document classification rendered by the SVM document classifier.

2. The system of claim 1, further comprising a third computing platform including a third memory, and one or more third computing processor devices in communication with the third memory, wherein the third memory stores a metadata extractor and analyzer executable by at least one of the one or more third computing processor devices and configured to:
receive the batch of documents,
extract metadata from each digital document in the batch of documents including document creation date, any document modification date, and any modified document parameters,
analyze the extracted metadata to determine for one or more the digital documents in the batch of digital documents that the document creation date and the document modification date are (i) a same date or (ii) different dates, and
communicate extracted metadata and results of extracted metadata analysis to the SVM platform,
wherein the SVM document classifier is further configured to implement the at least one of the one or more SVM algorithms to classify each digital document in the batch of digital documents as (i) valid document or (ii) invalid document based further on the extracted metadata and the results of extracted metadata analysis.

3. The system of claim 2, further comprising a third computing platform including a third memory, and one or more third computing processor devices in communication with the third memory, wherein the third memory stores an intelligent document processing engine executable by at least one of the one or more third computing processor devices and configured to:
receive the batch of documents,
capture an image of each digital document in the batch of documents,
implement Artificial Intelligence (AI) including Machine Learning (ML) on the captured image to classify each digital document and extract data from each digital document in the batch of documents based on the classification,
implement a rules engine to verify authenticity of each digital document in the batch documents by applying classification-specific rules to the extracted data, and
communicate results of document authenticity validation to the SVM platform,
wherein the SVM document classifier is further configured to implement the at least one of the one or more SVM algorithms to classify each digital document in the batch of digital documents as (i) valid document or (ii) invalid document is based further on the results of document authenticity validation performed by the intelligent document processing engine.

4. The system of claim 3, wherein the intelligent document processing engine is further configured to implement a rules engine to verify authenticity of each digital document in the batch documents by applying classification-specific rules to the extracted data, wherein the classification-specific rules are based on at least one of (i) text spelling, (ii) font style, (iii) font size, (iv) color, (v) alignment, and (vi) clarity.

5. The system of claim 1, wherein the digital document authenticity validation engine is further configured to verify authenticity of the barcodes including:
detect at least one barcode in one or more of the digital documents in the batch of digital documents,
extract the at least one barcode from the one or more of the digital documents in the batch of digital documents, and
verify (i) a pattern of the least one barcode and (ii) a position of the least one barcode, wherein the pattern and position of the least one barcode are specific to a document type.

6. The system of claim 1, wherein the digital document authenticity validation engine is further configured to verify authenticity of the images including:
detect at least one image in one or more of the digital documents in the batch of digital documents,
extract the at least one image from the one or more of the digital documents in the batch of digital documents, and
verify (i) alignment of the least one image and (ii) position of the least one image, (iii) size of the least image in comparison to a known reference image, wherein the alignment, position, and size of the least one image are specific to the image classification.

7. The system of claim 1, wherein the digital document authenticity validation engine is further configured to verify authenticity of the signatures including:
detect at least one signature in one or more of the digital documents in the batch of digital documents, wherein the at least signature comprises (i) a physical signature, or (ii) an electronic signature (e-signature),
extract at least one signature from the one or more of the digital documents in the batch of digital documents, and
verify at least one of (i) shape of the least one signature, (ii) smoothness of the least of signature, and (iii) line thickness of the least one signature in comparison to a known reference signature.

8. The system of claim 1, wherein the SVM document classifier is configured to classify each digital document in the batch of digital documents as (i) valid document or (ii) invalid document including:
assigning a validity value to each digital document based at least on the results of barcode, image, and signature authenticity validation,
comparing each of the validity values to a corresponding predetermined validity threshold value, wherein the corresponding predetermined validity threshold value is based on document type, and
classify each documents in the batch of digital documents as (i) valid document based on the validity value being at or above the corresponding predetermined validity threshold value and (ii) invalid document based on the validity value being below the corresponding predetermined validity threshold value.

9. A computer-implemented method for identification of document tampering, the computer-implemented method is executable by one or more computing processor devices, the method comprising:
receiving a batch of digital documents;
implementing at least one Support Vector Machine (SVM) algorithm to verify authenticity of barcodes present within one or more of the digital documents in the batch of digital documents;
implementing at least one SVM algorithm including at least one image classifier model to classify images present within one or more of the digital documents in the batch of digital documents and verify authenticity of the images;
implementing at least one SVM algorithm to verify authenticity of signatures provided by a signatory and present within one or more of the digital documents in the batch of digital documents;
implementing at least one SVM algorithm to classify each digital document in the batch of digital documents as (i) valid document or (ii) invalid document based, at least, on the results of barcode, image, and signature authenticity validation; and
implementing neuro-symbolic Artificial Intelligence (AI) to perform symbolic logical reasoning based at least on expert knowledge and neural network analysis to verify, for each digital document in the batch of documents, a correctness of (i) the valid document or (ii) the invalid document classification.

10. The computer-implemented method of claim 9, further comprising:
extracting metadata from each digital document in the batch of documents including document creation date, any document modification date, and any modified document parameters; and
analyzing the extracted metadata to determine for one or more the digital documents in the batch of digital documents that the document creation date and the document modification date are (i) a same date or (ii) different dates, and
wherein implementing the at least one SVM algorithm to classify each digital document in the batch of digital documents as (i) valid document or (ii) invalid document is based further on the extracted metadata and the results of extracted metadata analysis.

11. The computer-implemented method of claim 9, further comprising:
capturing an image of each digital document in the batch of documents;
implementing Artificial Intelligence (AI) including Machine Learning (ML) on the captured image to classify each digital document and extract data from each digital document in the batch of documents based on the classification; and
implementing a rules engine to verify authenticity of each digital document in the batch documents by applying classification-specific rules to the extracted data, and
wherein implementing the at least one SVM algorithm to classify each digital document in the batch of digital documents as (i) valid document or (ii) invalid document is based further on the results of document authenticity validation performed by the intelligent document processing engine.

12. The computer-implemented method of claim 11, wherein implementing the rules engine to verify authenticity of each digital document further comprises:
implementing the rules engine to verify authenticity of each digital document in the batch documents by applying classification-specific rules to the extracted data, wherein the classification-specific rules are based on at least one of (i) text spelling, (ii) font style, (iii) font size, (iv) color, (v) alignment, and (vi) clarity.

13. The computer-implemented method of claim 9, wherein implementing the at least one SVM algorithm to verify authenticity of barcodes further comprises:
detecting at least one barcode in one or more of the digital documents in the batch of digital documents;
extracting the at least one barcode from the one or more of the digital documents in the batch of digital documents; and
verifying (i) a pattern of the least one barcode and (ii) a position of the least one barcode, wherein the pattern and position of the least one barcode are specific to a document type.

14. The computer-implemented method of claim 9, wherein implementing the at least one SVM algorithm to verify authenticity of the images further comprises:
detecting at least one image in one or more of the digital documents in the batch of digital documents;
extracting the at least one image from the one or more of the digital documents in the batch of digital documents, and
verifying (i) alignment of the least one image and (ii) position of the least one image, (iii) size of the least image in comparison to a known reference image, wherein the alignment, position, and size of the least one image are specific to the image classification.

15. The computer-implemented method of claim 9, wherein implementing the at least one SVM algorithm to verify authenticity of signatures further comprises:
detecting at least one signature in one or more of the digital documents in the batch of digital documents, wherein the at least signature comprises (i) a physical signature, or (ii) an electronic signature (e-signature);
extracting at least one signature from the one or more of the digital documents in the batch of digital documents; and
verifying at least one of (i) shape of the least one signature, (ii) smoothness of the least of signature, and (iii) line thickness of the least one signature in comparison to a known reference signature.

16. A computer program product including a non-transitory computer-readable medium, the non-transitory computer-readable medium comprising:
a first set of codes for causing a computing device to receive a batch of digital documents;
a second set of codes for causing a computing device to implement at least one Support Vector Machine (SVM) algorithm to verify authenticity of barcodes present within one or more of the digital documents in the batch of digital documents;
a third set of codes for causing a computing device to implement at least one SVM algorithm including at least one image classifier model to classify images present within one or more of the digital documents in the batch of digital documents and verify authenticity of the images;
a fourth set of codes for causing a computing device to implement at least one SVM algorithm to verify authenticity of signatures provided by a signatory and present within one or more of the digital documents in the batch of digital documents;
a fifth set of codes for causing a computing device to implement at least one SVM algorithm to classify each digital document in the batch of digital documents as (i) valid document or (ii) invalid document based, at least, on the results of barcode, image, and signature authenticity validation; and
a sixth set of codes for causing a computing device to implement neuro-symbolic Artificial Intelligence (AI) to perform symbolic logical reasoning based at least on expert knowledge and neural network analysis to verify, for each digital document in the batch of documents, a correctness of (i) the valid document or (ii) the invalid document classification.

17. The computer program product of claim 16, wherein the computer-readable medium further comprises:
a seventh set of codes for causing a computing device to extract metadata from each digital document in the batch of documents including document creation date, any document modification date, and any modified document parameters; and
an eighth set of codes for causing a computing device to analyze the extracted metadata to determine for one or more the digital documents in the batch of digital documents that the document creation date and the document modification date are (i) a same date or (ii) different dates, and
wherein the fifth set of codes are further configured to cause the computing device to implement the at least one SVM algorithm to classify each digital document in the batch of digital documents as (i) valid document or (ii) invalid document is based further on the extracted metadata and the results of extracted metadata analysis.

18. The computer program product of claim 16, wherein the computer-readable medium further comprises:
a seventh set of codes for causing a computing device to capture an image of each digital document in the batch of documents;
an eighth set of codes for causing a computer device to implement Artificial Intelligence (AI) including Machine Learning (ML) on the captured image to classify each digital document and extract data from each digital document in the batch of documents based on the classification; and
a ninth set of codes for causing a computing device to implement a rules engine to verify authenticity of each digital document in the batch documents by applying classification-specific rules to the extracted data, and
wherein the fifth set of codes are further configured to cause the computing device to implement the at least one SVM algorithm to classify each digital document in the batch of digital documents as (i) valid document or (ii) invalid document is based further on the results of document authenticity validation performed by the intelligent document processing engine.

19. The computer program product of claim 18, wherein the seventh set of codes are further configured to cause the computer to implement the rules engine to verify authenticity of each digital document in the batch documents by applying classification-specific rules to the extracted data, wherein the classification-specific rules are based on at least one of (i) text spelling, (ii) font style, (iii) font size, (iv) color, (v) alignment, and (vi) clarity.

20. The computer program product of claim 16, wherein the second set of codes are further configured to cause the computer to (i) detect at least one barcode in one or more of the digital documents in the batch of digital documents, (ii) extract the at least one barcode from the one or more of the digital documents in the batch of digital documents, and (iii) verify (a) a pattern of the least one barcode and (b) a position of the least one barcode, wherein the pattern and position of the least one barcode are specific to a document type, and
wherein the third set of codes are further configured to cause the computer to (i) detect at least one image in one or more of the digital documents in the batch of digital documents, (ii) extract the at least one image from the one or more of the digital documents in the batch of digital documents, and (iii) verifying (a) alignment of the least one image and (b) position of the least one image, and (c) size of the least image in comparison to a known reference image, wherein the alignment, position and size of the least one image are specific to the image classification, and
wherein the fourth set of codes are further configured to cause the computer to (i) detect at least one signature in one or more of the digital documents in the batch of digital documents, wherein the at least one signature comprises (a) a physical signature, or (b) an electronic signature (e-signature), (ii) extract at least one signature from the one or more of the digital documents in the batch of digital documents, and (iii) verifying at least one of (a) shape of the least one signature, (b) smoothness of the least one signature, and (c) line thickness of the least one signature in comparison to a known reference signature.
